(19) United States
(12) Patent Application Publication
(10) Pub. No.: US 2021/0133289 A1
(43) Pub. Date: May 6, 2021

(54) SYSTEMS FOR REAL-TIME INTERNATIONAL CONVERSIONS IN A PUBLIC DISTRIBUTION ENVIRONMENT

(71) Applicant: BANK OF AMERICA CORPORATION, CHARLOTTE, NC (US)

(72) Inventors: Joseph Benjamin Castinado, North Glenn, CO (US); Martha Sain McClellan, Lancaster, SC (US); Lee Ann Proud, Ponte Vedra, FL (US); Kathleen Hanko Trombley, Oakboro, NC (US)

(73) Assignee: BANK OF AMERICA CORPORATION, CHARLOTTE, NC (US)

(21) Appl. No.: 16/673,011

(22) Filed: Nov. 4, 2019

(51) Int. Cl. G06F 17/28; H04W 4/021

(52) U.S. Cl. CPC G06F 17/289; H04W 4/021

(57) ABSTRACT

A system that provides for selection, at the onset of a resource event, between (i) a first resource event volume of a first resource type (i.e., a resource type associated with the resource-providing entity) and (ii) a second resource event volume of a second type (i.e., a resource type associated with the resource-receiving entity). The first resource event volume used in the selection is determined by applying a conversion rate to the second resource event volume near to or in conjunction with the initiation of the resource event. As a result, resource conversion occurs at the onset of the resource event as opposed to conventional processing which provides for the resource conversion at or near the conclusion of the resource event.

### FIELD OF THE INVENTION

The present invention is generally related to resource conversion and, more specifically, providing a user, located with a physical locale of a non-domestic object provider, an on-demand and definitive resource amount for an object of interest in the user's desired resource type, such that conversion rate used to determine the definitive resource amount(s) is defined at the onset of a resource event as opposed to at the conclusion of the resource event.

### BACKGROUND

Typically, when conducting a resource event that requires conversion of the resources from one resource type (i.e., a resource type associated with a first entity that is provided the resources) to a second resource type (i.e., a resource type associated with a second entity that is receiving the resources) the conversion occurs at or near the conclusion of the resource event. Since conventional resource events may occur over a period of days and conversion rates are prone to fluctuation, the first entity is unaware of the exact volume of resources of their associated resource type that are required when the resource event is initiated.

However, since conversion rates tend fluctuate in both positive and negative directions, the first entity may desire certainty in the exact volume of resources of their associated resource type when the resource event is initiated, while in other instances (e.g., when the conversion rate is trending in a positive direction) the first entity may prefer an uncertain scenario in which the conversion rate and, thus, the exact volume of resources are unknown until the resource event is at or near conclusion.

Therefore, a need exists to develop systems, methods, computer program products and the like that provide for more certainty as to the volume of resources required to conduct a resource event that requires conversion from one resource type to another. In addition, a need exists to develop systems, methods, computer program products and the like that allow entities entering into a resource event to select, at the onset of resource event, between application of a known conversion rate applied at the onset of the resource event or an unknown conversion rate applied at or near the conclusion of the resource event.

### BRIEF SUMMARY

The following presents a simplified summary of one or more embodiments of the invention in order to provide a basic understanding of such embodiments. This summary is not an extensive overview of all contemplated embodiments and is intended to neither identify key or critical elements of all embodiments, nor delineate the scope of any or all embodiments. Its sole purpose is to present some concepts of one or more embodiments in a simplified form as a prelude to the more detailed description that is presented later.

Embodiments of the present invention address the above needs and/or achieve other advantages by providing systems, methods, computer program product and/or the like that provide for a user, located within a non-domestic object provider locale, to be presented, on their mobile device, with the actual/definitive resource volume in their preferred resource type for an object of interest. In this regard, the conversion rate for converting the resource volume from the non-domestic/international type to the user's preferred/domestic type is applied at the time that the user inquires about the resource volume required to acquire the object (i.e., as the user contemplates acquiring an object while within the object provider locale). In this regard, the user benefits from having definitive knowledge prior to a resource event as to what the actual resource amount will be in their preferred resource type, since the conversion from the object provider's resource type to the user preferred resource type occurs prior to but proximate in time to the resource event including the object (i.e., as opposed to conventional processing in which the conversion occurs at or near the conclusion of the resource event).

In further embodiments of the invention, other conversions occur in addition to resource type conversion. For example, the language printed on or otherwise associated with the object may be translated from a first language type to a second language type preferred by the user and presented on the user's mobile device. Additionally, measurement information (i.e., size of object, volume/dimensions of object, and the like) associated with the object may be converted from a first measurement type to a second measurement type preferred by the user. Moreover, nutritional or health-related indices associated with the object may be converted from a first type to a second type preferred by the user.

A system for dynamic resource conversion defines first embodiments of the invention. The system includes a mobile device that is in possession of a user. The mobile device includes a memory, at least one computing processor in communication with the memory, and one or more user interfaces in communication with the at least one processor. The system additionally includes a plurality of computing-implemented instructions stored that are stored in the memory of the mobile device and executable by the at least one computing processor. The instructions are configured to receive, as the user is located within a non-domestic physical locale of an object provider, at least one input that identifies (i) an object in the physical locale, and (ii) a first resource volume of a first resource type required for acquiring the object. The instructions are further configured to, in response to receiving the at least one input, determine that resources in a first resource depository held by the user are of a second resource type different than the first resource type. In response to determining that the resources held in the resource are of a different type, the instructions are further configured to initiate determination of a second resource volume required for acquiring the object. The second resource volume is (i) of the second resource type, and (ii) determined by applying a resource type conversion rate to the first resource volume of the first resource type required for performing acquisition of the object. In addition, the instructions are configured to communicate a first signal to the mobile device that is configured to present on one of the one or more user interfaces the second resource volume as a definitive volume of resources of the second resource type required for acquiring the object.

In specific embodiments of the system, the instructions are further configured to, in response to the user initiating, at the physical locale, a subsequent resource event that includes the object, communicate a second signal to the mobile device that (i) is configured to be outputted by at least one of the one or more user interfaces, and (ii) provides presentation of an option to perform the subsequent resource event using the second resource type in a volume that includes the second resource volume for acquiring the object.

In further specific embodiments of the system, the subsequent resource event is initiated within a predetermined time period from when the second resource volume is presented on the user interface. In this regard, the second resource volume that is presented to the user is only valid for the predetermined period time (e.g., the time during which the user is located at the physical locale).

In still further specific embodiments of the system, the definitive volume of resources is further defined as an actual amount of resources transferred from the first resource depository to a second resource depository held by the object provider in response to a resource event that includes the object.

In other specific embodiments of the system, the instructions configured to receive the input are further configured to capture an image of computer-readable indicia located on the object and read the computer-readable indicia to identify (i) the object, and (ii) the first resource volume of a first resource type.

In other specific embodiments of the system, the instructions configured to communicate the first signal are further configured to communicate the first signal configured to present the resource conversion rate used to determine the second resource volume.

Moreover, in additional specific embodiments of the system, the instructions are further configured to (i) receive, as the user is located within the physical locale of an object provider, the at least one input that further identifies information related to the object in a first language, (ii) determine that the user prefers a second language, (iii) translate the information related to the object from the first language to the second language, and (iv) communicate a second signal to the mobile device that is configured to present on one of the one or more user interfaces the information related to the object in the second language.

In additional specific embodiments of the system, the instructions are further configured to (i) receive, as the user is located within the physical locale of an object provider, the at least one input that further identifies first measurement information of a first measurement type associated with the object, (ii) determine that the user prefers measurement information of a second measurement type, (iii) determine second measurement information of the second measurement type by applying a measurement conversion scale to the first measurement information, and (iv) communicate a second signal to the mobile device that is configured to present on one of the one or more user interfaces the second measurement information.

In yet other specific embodiments of the system, the instructions are further configured to (i) receive, as the user is located within a physical locale of an object provider, the at least one an input that further identifies first health-related information of a first type associated with the object, (ii) determine that the user prefers health-related information of a second type, (iii) determine second health-related information of the second type by applying a health-related conversion scale to the first health-related information, and (iv) communicate a second signal to the mobile device that is configured to present on one of the one or more user interfaces the second health-related information.

A computer-implemented method for dynamic resource conversion defines second embodiments of the invention. The computer-implemented method is executed by one or more computing device processors. The method includes receiving, by a mobile device in possession of a user located within a physical locale of an object provider, at least one input that identifies (i) an object within the physical locale, and (ii) a first resource volume of a first resource type required for acquiring the object. The method further includes, in response to receiving the at least one input, determining that resources in a first resource depository held by the user are of a second resource type different than the first resource type. In addition, the method includes initiating determination of a second resource volume required for acquiring the object. The second resource volume is (i) of the second resource type, and (ii) determined by applying a resource type conversion rate to the first resource volume of the first resource type required for performing acquisition of the object. In addition, the method includes communicating a first signal to the mobile device that is configured to present on one of the one or more user interfaces the second resource volume as a definitive volume of resources of the second resource type required for acquiring the object.

In specific embodiments the method further includes, in response to the user initiating, at the physical locale, a subsequent resource event that includes the object, communicating a second signal to the mobile device that (i) is configured to be outputted by at least one of the one or more user interfaces, and (ii) provides presentation of an option to perform the subsequent resource event using the second resource type in a volume that includes the second resource volume for acquiring the object.

In other specific embodiments of the method, the subsequent resource event is initiated within a predetermined time period from when the second resource volume is presented on the user interface. In still further specific embodiments of the method, the definitive volume of resources is further defined as an actual amount of resources transferred from the first resource depository to a second resource depository held by the object provider in response to a resource event that includes the object.

In still further specific embodiments of the method, receiving the at least one input further includes receiving, by a mobile device in possession of a user located within a physical locale of an object provider, the least one input that identifies information related to the object in a first language. In such embodiments the method further includes (i) determining that the user prefers a second language, (ii) translating the information related to the object from the first language to the second language, and (iii) communicating a second signal to the mobile device that is configured to present on one of the one or more user interfaces the information related to the object in the second language.

In further specific embodiments of the method, receiving the at least one input further includes receiving, by a mobile device in possession of a user located within a physical locale of an object provider, the at least one input that further identifies first measurement information of a first measurement type associated with the object. In such embodiments the method further includes (i) determining that the user prefers measurement information of a second measurement type, (ii) determining second measurement information of the second measurement type by applying a measurement conversion scale to the first measurement information, and (iii) communicating a second signal to the mobile device that is configured to present on one of the one or more user interfaces the second measurement information.

In still further specific embodiments of the method, receiving the at least one input further includes receiving, by a mobile device in possession of a user located within a physical locale of an object provider, the at least one an input that further identifies first health-related information of a first type associated with the object. In such embodiments the method further includes (i) determining that the user prefers health-related information of a second type, (ii) determining second health-related information of the second type by applying a health-related conversion scale to the first health-related information; and (iii) communicating a second signal to the mobile device that is configured to present on one of the one or more user interfaces the second health-related information.

A computer program product including a non-transitory computer-readable medium defines third embodiments of the invention. The computer-readable medium includes a first set of codes for causing a computer to receive, by a mobile device in possession of a user located within a physical locale of an object provider, at least one input that identifies (i) an object, and (ii) a first resource volume of a first resource type required for acquiring the object provided within the physical locale. The computer-readable medium additionally includes a second set of codes for causing a computer to, in response to receiving the at least one input, determine that resources in a first resource depository held by the user are of a second resource type different than the first resource type. In addition, the computer-readable medium includes a third set of codes for causing a computer to initiate determination of a second resource volume required for acquiring the object, wherein the second resource volume is (i) of the second resource type, and (ii) determined by applying a resource type conversion rate to the first resource volume of the first resource type required for performing acquisition of the object. Moreover, the computer-readable medium includes a fourth set of codes for causing a computer to communicate a first signal to the mobile device that is configured to present on one of the one or more user interfaces the second resource volume as a definitive volume of resources of the second resource type required for acquiring the object.

In additional embodiments of the computer program product the computer-readable medium further includes a fifth set of codes for causing a computer to, in response to the user initiating, at the physical locale, a subsequent resource event that includes the object within a predetermined time period from when the second resource volume is presented on the user interface, communicate a second signal to the mobile device that (i) is configured to be outputted by at least one of the one or more user interfaces, and (ii) provides presentation of an option to perform the subsequent resource event using the second resource type in a volume that includes the second resource volume for acquiring the object.

In other specific embodiments of the computer program product the first set of codes is further configured to receive, by a mobile device in possession of a user located within a physical locale of an object provider, the least one input that identifies information related to the object in a first language. In such embodiments of the computer program product the computer-readable medium includes (i) a fifth set of codes for causing a computer to determine that the user prefers a second language, (ii) a sixth set of codes for causing a computer to translate the information related to the object from the first language to the second language, and (iii) a seventh set of codes for causing a computer to communicate a second signal to the mobile device that is configured to present on one of the one or more user interfaces the information related to the object in the second language.

Moreover, in additional embodiments of the computer program product the first set of codes is further configured wherein receiving the at least one input further comprises receiving, by a mobile device in possession of a user located within a physical locale of an object provider, the at least one input that further identifies one or more of first measurement information of a first measurement type and first health-related information of a first health-related type associated with the object. In such embodiments of the computer program product the computer-readable medium additionally includes (i) a fifth set of codes for causing a computer to determine that the user prefers at least one of measurement information of a second measurement type and health-related information of a second health-related type, (ii) a sixth set of codes for causing a computer to determine at least one of second measurement information of the second measurement type and second health-related information of the second health-related type by applying at least one of a measurement conversion scale to the first measurement information and a health-related conversion scale to the first health-related information, and (iii) a seventh set of codes for causing a computer to communicate a second signal to the mobile device that is configured to present on one of the one or more user interfaces at least one of the second measurement information and the second health-related information.

Thus, according to embodiments of the invention, which will be discussed in greater detail below, the present invention provides for a user, located within a non-domestic object provider locale, to be presented, on their mobile device, with the actual/definitive resource volume in their preferred resource type for an object of interest. In this regard, the conversion rate for converting the resource volume from the non-domestic/international type to the user's preferred/domestic type is applied at the time that the user inquires about the resource volume required to acquire the object (i.e., as the user contemplates acquiring an object while within the object provider locale).

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the disclosure in general terms, reference will now be made to the accompanying drawings, wherein:

FIG. 1 is a schematic diagram of a system for dynamic resource conversion, in accordance with embodiments of the present invention;

FIG. 2 is a block diagram of a mobile device configured for dynamic resource conversion, in accordance with embodiments of the present invention;

FIG. 3 is a flow diagram of a method for dynamic resource conversion, in accordance with embodiments of the present invention;

FIG. 4 is a schematic diagram of a system for dynamic resource conversion and processing, in accordance with some embodiments of the present disclosure;

FIG. 5 is a block diagram of a computing platform including instructions configured for dynamic resource conversion and processing, in accordance with some embodiments of the present disclosure;

FIG. 6 is a flow diagram of a method for dynamic resource conversion and processing, in accordance with embodiment of the present invention;

FIG. 7 is schematic diagram of a user device configured for presentation of the resource conversation options, in accordance with some embodiments of the present disclosure; and

FIG. 8 is schematic diagram of a system for presentation of the resource conversation options, in accordance with some embodiments of the present disclosure.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout.

As will be appreciated by one of skill in the art in view of this disclosure, the present invention may be embodied as a system, a method, a computer program product or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer-readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as JAVA, PERL, SMALLTALK, C++, PYTHON or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or systems. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions, which implement the function/act specified in the flowchart and/or block diagram block or blocks.

The computer program instructions may also be loaded onto a computer or other programmable data processing apparatus to cause a series of operational events to be performed on the computer or other programmable apparatus to produce a computer implemented process such that the instructions, which execute on the computer or other programmable apparatus, provide events for implementing the functions/acts specified in the flowchart and/or block diagram block or blocks. Alternatively, computer program implemented events or acts may be combined with operator or human implemented events or acts in order to carry out an embodiment of the invention.

As the phrase is used herein, a processor may be “configured to” perform or “configured for” performing a certain function in a variety of ways, including, for example, by having one or more general-purpose circuits perform the function by executing particular computer-executable program code embodied in computer-readable medium, and/or by having one or more application-specific circuits perform the function.

Thus, according to embodiments of the invention, which will be described in more detail below, systems, methods and computer program products are disclosed that provide for a user, located within a non-domestic object provider locale, to be presented, on their mobile device, with the actual/definitive resource volume in their preferred resource type for an object of interest. In this regard, the conversion rate for converting the resource volume from the non-domestic/international type to the user's preferred/domestic type is applied at the time that the user inquires about the resource volume required to acquire the object (i.e., as the user contemplates acquiring an object while within the object provider locale). In this regard, the user benefits from having definitive knowledge prior to a resource event as to what the actual resource amount will be in their preferred resource type, since the conversion from the object provider's resource type to the user preferred resource type occurs prior to but proximate in time to the resource event including the object (i.e., as opposed to conventional processing in which the conversion occurs at or near the conclusion of the resource event).

In further embodiments of the invention, other conversions occur in addition to resource type conversion. For example, the language printed on or otherwise associated with the object may be translated from a first language type to a second language type preferred by the user and presented on the user's mobile device. Additionally, measurement information (i.e., size of object, volume/dimensions of object, and the like) associated with the object may be converted from a first measurement type to a second measurement type preferred by the user. Moreover, nutritional or health-related indices associated with the object may be converted from a first type to a second type preferred by the user.

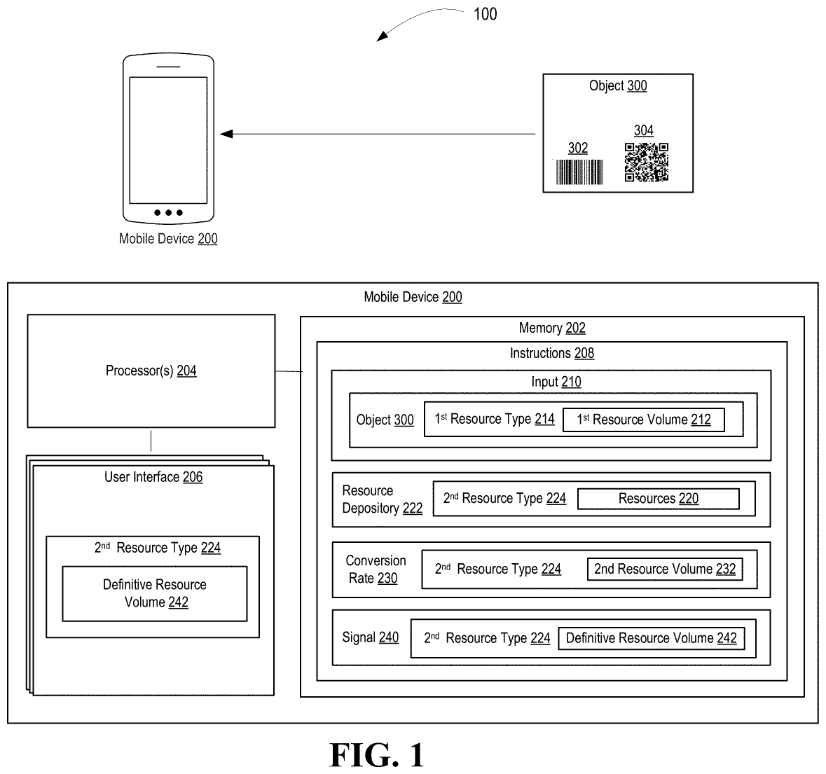

Turning now to the figures, FIG. 1 illustrates a system 100 for dynamic resource conversion, in accordance with embodiments of the present invention. The system 100 includes a mobile device 200 having a memory 202, at least one processing device 204 in communication with the memory 202 and one or more user interfaces (e.g., display, speaker or the like) in communication with the at least one processing device 204. The mobile device is in possession of a user that is located within a non-domestic physical locale of an object provider. In specific embodiments of the invention the non-domestic physical locale is an international/foreign retail location (e.g., the retail location is non-domestic/foreign in relation the user, i.e., the user is from/domiciled in a first country and the physical locale is in a second country) and the object provider is a retailer that offers products for sale.

The system 100 additionally includes a plurality of computer-implemented instructions 208 stored in the memory 202 and executable by the processing device(s) 204. The instructions 208 are configured to receive at least one input 210 that identifies (i) an object 300 at the physical locale, and (ii) a first resource volume 212 of a first resource type 214 required for acquiring the object. In specific embodiments of the invention, in which the object 300 is a product at a retail location or the like, the input may be received by using an image-capturing device within the mobile device 300 to capture an image of computer-readable indicia (e.g., barcode 302, Quick Response (QR) code 304 or the like) disposed on the product and subsequently read the computer-readable indicia. In those embodiments of the invention in which the object 300 is a product, the first resource volume 212 is the price of the product and the first resource type 214 is the type of currency accepted by the retailer/merchant (e.g., the currency accepted within the non-domestic physical locale, common to the country where the user is located/shopping).

In response to receiving the at least one input 210, the instructions 208 are further configured to determine 250 that the resources 220 in a resource depository 222 held by the user are of a second resource type 224 different than the first resource type 214 (i.e., that the user prefers to perform resource events using resources different in type than the resources accepted by the object provider). In those embodiments of the invention in which the resources 220 are monetary funds and the resource depository 222 is a financial account held by the user, the second resource type 224 is a currency type different than the currency type accepted by the retailer/merchant. In specific embodiments of the invention, the instructions 208 may be configured for determining 250 the different resource type by accessing a user profile that indicates that the user prefers or otherwise holds resource depositories of the second resource type 224 (i.e., the resource type associated with the user's financial account(s) or the like).

In response to determining that the second resource type 224 is different than the first resource type 214, the instructions 208 are configured to initiate determination 260 of a second resource volume 232 required for acquiring the object 300. The second resource volume 232 is determined by applying a second resource type-specific conversion rate 230 to the first resource volume 212 of the first resource type 214. In specific embodiments of the invention, in which the resource types are currency types, the second resource volume 232 is the price of the object 300/product in the user's preferred currency type and is determined by applying a conversion rate 230 associated with the user's preferred currency type to the price of the object 300/product in the non-domestic physical locale's currency type. In this regard, according to the present invention, currency conversion occurs prior to or at the time of a payment transaction as opposed to conventional payment transactions requiring currency conversion, in which the conversion occurs at the time of settlement, which may be days after the occurrence of the transaction.

In response to converting the resource volume to the second resource type 224, the instructions 208 are configured to communicate a first signal 240 to at least one of the user interfaces 206 that is configured to present on the user interface 206 (e.g., display on the mobile device) a definitive resource volume 242 of the second resource type 224 that includes the second resource volume 232. The definitive resource volume 242 is the actual volume of resources that are transferred from the user's resource depository 222 in response to performing a resource event that includes the object 300 or the resource volume otherwise owed by the user. In specific embodiments of the invention, in which the object is a product provided by a retailer or the like, the definitive resource volume 242 is the actual amount of funds that the transferred from the user's financial account as a result of the payment transaction or the amount of funds owed by the user. In addition, to the converted amount of funds of the user's preferred currency type required to acquire the object 300/product, the definitive resource volume may include other assessments, such as, but not limited to, credit card assessments, network rate assessments and any other assessment.

In specific embodiments of the invention, in which the user is browsing objects 300/products (i.e., shopping) at a non-domestic retailer locale, the user may scan a barcode/QR code on a product and the mobile device may display the definitive price in the user's preferred currency for the object/product. The definitive price may be valid for a specified period of time (e.g., for the duration of a typical shopping experience at the non-domestic retailer locale or the like) to allow the user to further browse/shop within the retail locale before deciding to purchase the object/product. At the time of the transaction the user may be presented with an option to acquire the object/product using the definitive price or to forego performing the currency exchange at the time of transaction, perform the transaction in the non-domestic retailer's currency type and have the currency change occur subsequently at the time of settlement.

In still further specific embodiments of the invention, in which the object 300 is a product, and the mobile device 200 includes multiple different digital wallets, with different digital wallets having different payment vehicles (i.e., different credit cards and or different payment accounts associated with different digital wallets), the signal 240 may be configured to present on the user interface 206 multiple different definitive payment amounts for the product (i.e., different definitive resource volumes 242). The different definitive payment amounts reflecting different assessments, such as different credit card assessments, different network rate assessments or the like associated with different credit cards, network rates or the like. In this regard, the user can then choose the definitive payment amount that they desire to use (e.g., the lowest definitive payment amount or the definitive payment amount that includes the best rewards or the like).

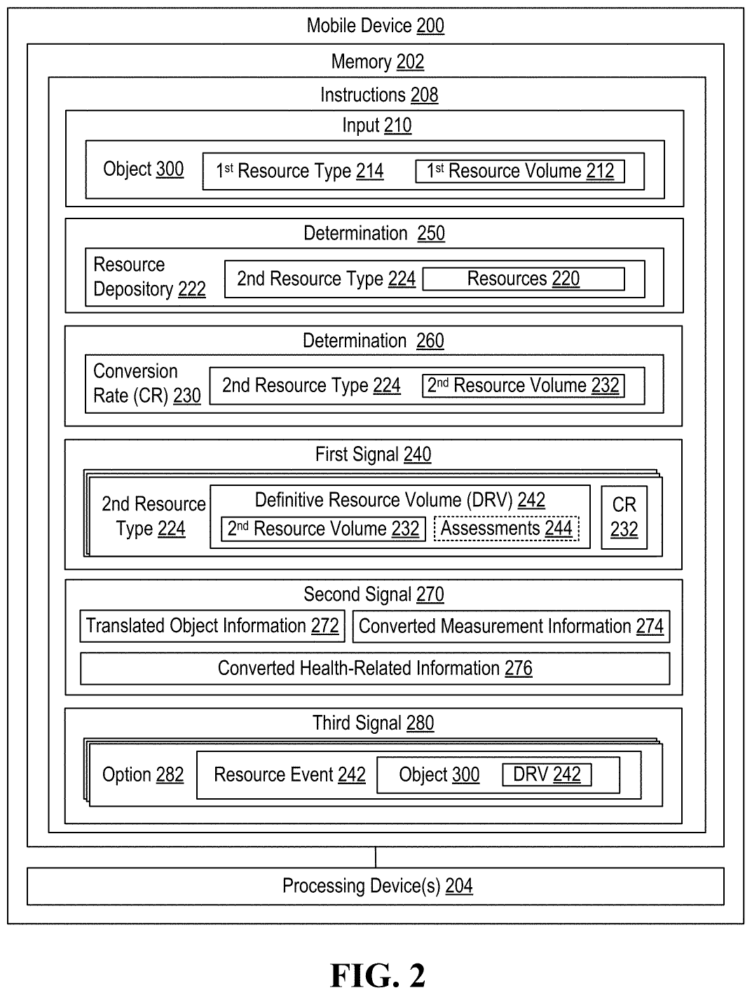

Referring to FIG. 2, a block diagram is presented of the mobile device 200 configured for dynamic resource conversion, in accordance with embodiments of the present invention. Mobile device 200 is configured to execute instructions 208, such as algorithms, modules, routines, applications and the like. Mobile device 200 includes memory 202, which may comprise volatile and non-volatile memory, such as read-only and/or random-access memory (RAM and ROM), EPROM, EEPROM, flash cards, or any memory common to computing platforms). Moreover, memory 200 may comprise cloud storage, such as provided by a cloud storage service and/or a cloud connection service.

Further, mobile device 200 also includes at least one processing device (i.e., processor) 204, which may be an application-specific integrated circuit (“ASIC”), or other chipset, logic circuit, or other data processing device. Processing device(s) 204 may execute one or more application programming interface (APIs) (not shown in FIG. 2) that interface with any resident programs, such as instructions 208 or the like, stored in the memory 202 of the mobile device 200 and any external programs. Processing devices(s) 404 may include various processing subsystems (not shown in FIG. 2) embodied in hardware, firmware, software, and combinations thereof, that enable the functionality of mobile device 200 and the operability of the mobile device on a distributed communication network. For example, processing subsystems allow for initiating and maintaining communications and exchanging data with other networked devices. For the disclosed aspects, processing subsystems of processing device 204 may include any subsystem used in conjunction with instructions 208 and related tools, routines, sub-routines, algorithms, sub-algorithms, sub-modules thereof.

Mobile device 200 may additionally include a communications module (not shown in FIG. 2) embodied in hardware, firmware, software, and combinations thereof, that enables electronic communications between the mobile device 200 and other network devices. Thus, communication module may include the requisite hardware, firmware, software and/or combinations thereof for establishing and maintaining a network communication connection with one or more network devices.

Memory 202 of mobile device 200 stores instructions 208 that are configured to receive at least one input 210 that identifies to receive, at a non-domestic physical locale that provides objects, at least one input 210 that identifies (i) an object 300 at the physical locale, and (ii) a first resource volume 212 of a first resource type 214 required for acquiring the object. As previously discussed, in specific embodiments of the invention, in which the object 300 is a product/good at a retail location or the like, the input may be received by using an image-capturing device within the mobile device 300 to capture an image of computer-readable indicia (e.g., barcode 302, QR code 304 (shown in FIG. 1) or the like) affixed on or associated with the product/good and subsequently read the computer-readable indicia. In those embodiments of the invention in which the object 300 is a product, the first resource volume 212 is the price of the object and the first resource type 214 is the type of currency accepted by the object provider/retailer (e.g., the currency accepted within the non-domestic physical locale).

In response to receiving the at least one input 210, the instructions 208 are further configured to determine that the resources 220 in a resource depository 222 held by the user are of a second resource type 224 different than the first resource type 214. In those embodiments of the invention in which the resources are monetary funds and the resource depository 222 is a financial account held by the user, the second resource type 224 is a currency type different than the currency type accepted by the object provider/retailer. In specific embodiments of the invention, the instructions 208 may be configured for the user to input their preferred second resource type 224 (i.e., the resource type associated with the user's financial account(s) or the like).

In response to determining that the second resource type 224 is different than the first resource type 214, the instructions 208 are configured to initiate determination of a second resource volume 232 required for acquiring the object 300. The second resource volume 232 is determined by applying a second resource type-specific conversion rate 230 to the first resource volume 212 of the first resource type 214. In specific embodiments of the invention, in which the resource types are currency types, the second resource volume 232 is the price of the object 300/product in the user's preferred currency type and is determined by applying a conversion rate 230 associated with the user's preferred currency type to the price of the object 300/product in the non-domestic physical locale's currency type. In this regard, the currency conversion occurs prior to the payment transaction as opposed to conventional payment transactions requiring currency conversion, in which the conversion occurs at the time of settlement, which may be days after the transaction.

In response to converting the resource volume to the second resource type 224, the instructions are configured to communicate a signal 240 to at least one of the user interfaces 206 that is configured to present on the user interface 206 a definitive resource volume 242 of the second resource type 224 that includes the second resource volume 232. The definitive resource volume 242 is the actual volume of resources that are transferred from the user's resource depository 222 in response to performing a resource event that includes the object 300 or the resource volume otherwise owed by the user. In specific embodiments of the invention, in which the object is a product provided by a retailer/merchant or the like, the definitive resource volume 242 is the actual amount of funds that are transferred from the user's financial account as a result of the payment transaction or the amount of funds owed by the user. In addition, to the converted amount of funds of the user's preferred currency type required to acquire the object 300/product, the definitive resource volume 242 may include other assessments 244, such as, but not limited to, credit card assessments, network rate assessments and any other assessment. Moreover, the first signal 240 may be configured to present on the user interface 206 the conversion rate 230 that was used to determine the second resource volume 232.

In specific embodiments of the invention, the instructions 208 may be further configured to receive other inputs (or the same inputs discussed above) that identify information related to the object 300 in a first language type. In such embodiments of the invention, the instructions are configured to determine whether the user prefers a second language type different from the first language type. In the event that the user prefers the second language type, the instructions are configured to translate the information related to the object 300 from the first language to the second language. In addition, the instructions 208 are configured to communicate a second signal 270 to one or more of the user interfaces that provide for presentation of the translated object information 272 (i.e., the information related to the object 300 in the second language).

In further specific embodiments of the invention, the instructions 208 may be further configured to receive other inputs (or the same inputs discussed above) that further identify measurement information related to the object 300 in a first measurement type (e.g., metric system measurement type). For example, the measurement information may be the dimensions of the object, the weight of the object, the volume of the object or the size of the object. In such embodiments of the invention, the instructions are configured to determine whether the user prefers a second measurement type (e.g., English system measurement type) different from the first measurement type. In the event that it is determined that the user prefers the second measurement type, the instructions are configured to convert the measurement information related to the object 300 from the first measurement type to the second measurement type. In addition, the instructions 208 are configured to communicate a second signal 270 to one or more of the user interfaces that provide for presentation of the converted measurement information 274.

In still further specific embodiments of the invention, the instructions 208 may be further configured to receive other inputs (or the same inputs discussed above) that further identify health-related information related to the object 300 in a first health-related type (e.g., metric system type). For example, the health-related information may be the nutritional information, dosage amount information or the like. In such embodiments of the invention, the instructions are configured to determine whether the user prefers a second health-related type (e.g., English system type) different from the first health-related type. In the event that it is determined that the user prefers the second health-related type, the instructions are configured to convert the health-related information related to the object 300 from the first health-related type to the second health-related type. In addition, the instructions 208 are configured to communicate a second signal 270 to one or more of the user interfaces that provide for presentation of the converted health-related information 276.

Additionally, instructions 208 may be configured to communicate a third signal 280 to one or more of the user interfaces of the mobile device 200 that presents an option 282 to the user to conduct a resource event 242 that includes the object 300 using the definitive resource volume 242 previously determined for the object 300 or, conduct the resource event using the first resource volume 212 or the first resource type 214 for the object 300. In specific embodiments of the invention, in which the object 300 is a product/good offered by a merchant, the option is presented for the user to conduct a transaction using funds of their preferred type in which the amount is locked-in at the time of the transaction or to conduct the transaction in the funds of the non-domestic locale (i.e., foreign country), in which the exact payment amount is unknown since the foreign exchange/conversion will not occur until the transaction is settled at a later point in time.

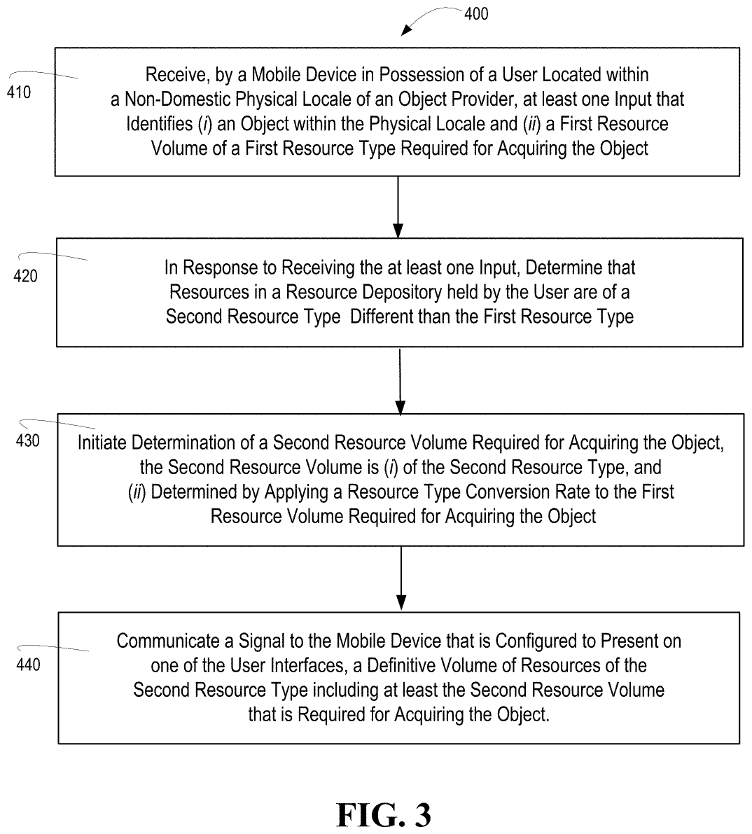

Referring to FIG. 3 a flow diagram of a method 400 for dynamic resource conversion, in accordance with embodiments of the present invention. At Event 410, an input is received by mobile device in possession of user located within a non-domestic physical locale of an object provider. In specific embodiments of the method, the user is located in a foreign retailer location that offers products/goods or the like. The input is configured to that identifies (i) an object at the physical locale, and (ii) a first resource volume of a first resource type required for acquiring the object. In specific embodiments of the method, in which the object is a product/good available at a retail location or the like, the input is received by the mobile device using an image-capturing device within the mobile device to capture an image of computer-readable indicia (e.g., barcode, QR code or the like) affixed to or associated with the product/good and subsequently read the computer-readable indicia. In those embodiments of the method in which the object is a product/good, the first resource volume is the price of the product/good and the first resource type is the type of currency accepted by the retailer (e.g., the currency accepted within the non-domestic physical locale).

In response to receiving the at least one input, at Event 420, a determination is made that the resources in a resource depository held by the user are of a second resource type that is different than the first resource type. In those embodiments of the method in which the resources are monetary funds and the resource depository is a financial account held by the user, the second resource is a currency type different than the currency type accepted by the object provider/retailer (e.g., the user's financial account is in United States currency and the retailer accepts Canadian currency). In specific embodiments of the method, the determination entails accessing a user profile that defines the second resource type as the resource type associated with the user's resource depository(s).

In response to determining that the second resource type is different than the first resource type, at Event 430, determination of a second resource volume required for acquiring the object is initiated. The determination may occur locally within the mobile device or the mobile device may communicate a signal to entity to initiate determination of the second resource volume. The second resource volume is determined by applying a second resource type-specific conversion rate to the first resource volume of the first resource type. In specific embodiments of the method, in which the resource types are currency types, the second resource volume is the price of the product/good in the user's currency type and is determined by applying a conversion rate associated with the user's currency type to the price of the product/good in the foreign retailer's currency type. In this regard, the currency conversion that determines the price in the user's currency type occurs prior to the payment transaction as opposed to conventional payment transactions that require currency conversion, in which the conversion occurs at the time of settlement, which may be days after the transaction occurs.

In response to converting the resource volume to the second resource type, at Event 440, a signal is communicated to at least one of the user interfaces on the mobile device that is configured to present on the user interface a definitive resource volume of the second resource type that includes the second resource volume. The definitive resource volume is the actual volume of resources that are transferred from the user's resource depository in response to performing a resource event that includes the object or otherwise owed by the user. In specific embodiments of the method, in which the object is a product/good provided/offered by a retailer or the like, the definitive resource volume is the actual amount of funds that are transferred from the user's financial account as a result of the payment transaction or is otherwise owed by the user. In addition, to the converted amount of funds of the user's preferred currency type required to acquire the product/good, the definitive payment amount may, but is not required to, include other assessments, such as, but not limited to, credit card assessments, network rate assessments and any other assessment.

In specific embodiments of the invention, in which the user is browsing products/goods (i.e., shopping) at a non-domestic retailer locale, the user may scan a barcode/QR code on a product and the mobile device may display the definitive price in the user's preferred currency for the product/good. In such a case, the definitive price may be valid for a specified period of time (e.g., for the duration of a typical shopping experience at the non-domestic retailer locale or the like) to allow the user to further browse/shop within the retail locale before deciding to purchase the object/product. At the time of the transaction the user may be presented with an option to acquire the object/product using the definitive price or to forego performing the currency exchange at the time of transaction, perform the transaction in the non-domestic retailer's currency type and have the currency change occur subsequently at the time of settlement.

In still further specific embodiments of the invention, in which the object is a product/good, and the mobile device includes multiple different digital wallets, with different digital wallets having different payment vehicles (i.e., different credit cards and or different payment accounts associated with different digital wallets), the signal may be configured to present on the user interface multiple different definitive payment amounts for the product (i.e., different definitive resource volumes). The different definitive payment amounts reflecting different assessments, such as different credit card assessments, different network rate assessments or the like associated with different credit cards, network rates or the like. In this regard, the user can then choose the definitive payment amount that they desire to use for the transaction (e.g., the lowest definitive payment amount or the definitive payment amount that includes the best rewards or the like).

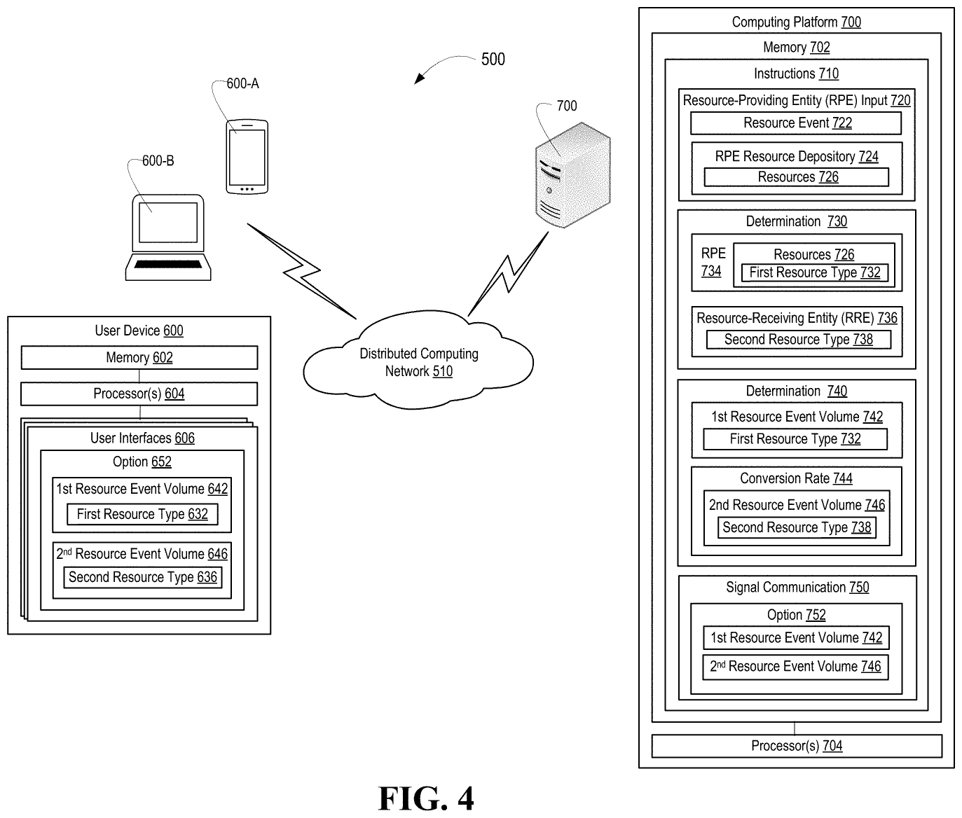

Referring, FIG. 4 illustrates a system 500 for dynamic resource conversion and processing, in accordance with embodiments of the present invention. The system 500 is implemented in a distributed computing network 510, which may include the Internet, one or more intranets, short-range wireless networks or any combination thereof. The system additionally includes a user device 600 that may comprise a mobile communication device 600-A and/or another networked device, such as a personal computer 600-B, laptop or the like. The user device includes a memory 602, one or more processors 604 in communication with the memory 602, and one or more user interfaces 606 in communication with the processor that are configured to output data to the user. In this regard, the user interfaces 606 may comprises a display, a microphone or the like.

The system additionally includes a computing platform 700 which may comprise one or more servers (as shown in FIG. 4), or one or more other computing devices, such as a point-of-sale (POS) terminal. In other embodiments of the invention, some, or all, of the functionality provided by the computing platform 700 may be included in user device 600. The computing platform includes a memory 702 and one or more processors 704 in communication with the memory 702. The memory 702 stores a plurality of instructions 710 which are executable by the one or more processors 704. The instructions 710 are configured to receive an input 720 from a resource-providing entity 734 in control of the user device 600, that requests performance of a resource event 722 between the resource-providing entity 734 and a resource-receiving entity 736. The resource event 722 is to be performed using resources 726 from a resource depository 724 in control of the resource-providing entity 734.

In response to receiving the input 720, the instructions 710 are configured to perform a determination 730 that verifies/determines that the resources 726 in the resource depository 724 are of a first resource type 732 and that the resource-receiving entity 734 is configured to receive resources of a second resource type 738 that is different from the first resource type 732. In response to determination 730, the instructions 710 are further configured to perform a determination 740 that renders/determines a first resource event volume 742 for performing the resource event 722. The first resource event volume 742 is of the first resource type 732 and is determined by applying a resource type conversion rate 744 to a second resource event volume 746 of the second resource type 738 required for performing the resource event 322.

In response to determining the first resource event volume 742, the instructions 710 are configured to generate and communicate a signal 750 to the user device 600 that is configured to present, on one or more of the user interfaces 606, an option 752 for selecting between performing the resource event 722 with the first resource event volume 742 of the first resource type 732 or the second resource event volume 746 of the second resource type 738.

In response to the user selecting the first resource event volume 742, the resource event 722 is performed with resources 726 being provided to the resource-receiving entity 736 from the resource depository 724 in a volume equal to the selected first resource event volume 742.

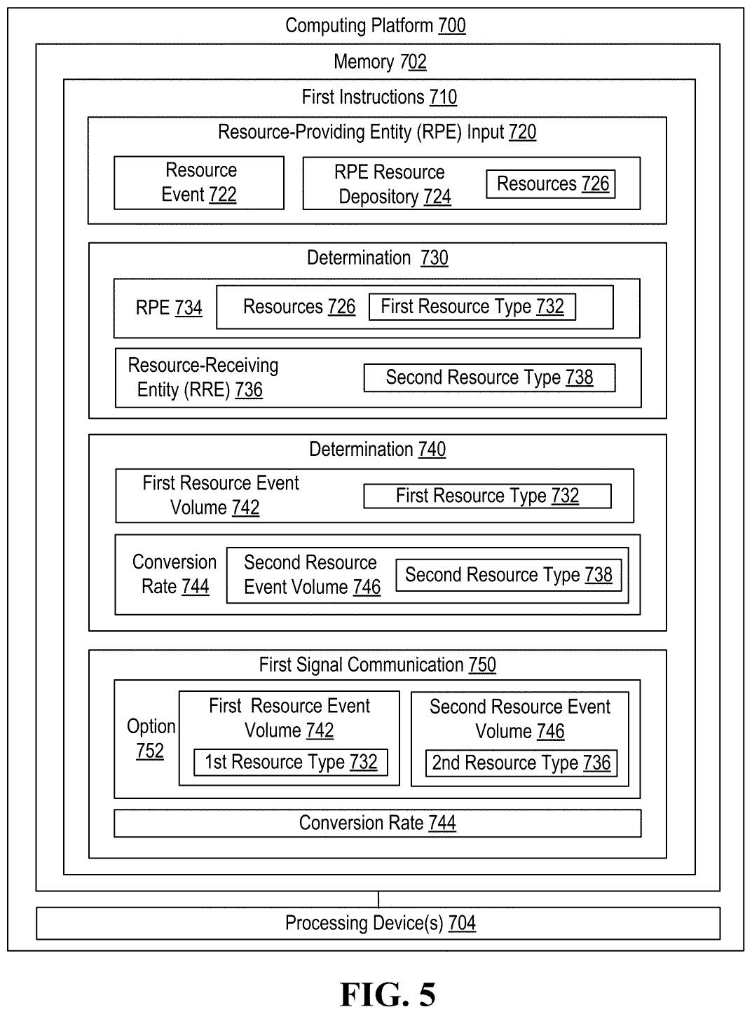

Referring to FIG. 5 a block diagram is depicted of computing platform 700 having first instructions 710 for dynamic resource conversion and processing, in accordance with embodiments of the present invention. Computing platform 700, which may comprise one or more computing devices (e.g., servers, computing devices, POS terminals or the like), is configured to execute instructions 710, such as algorithms, modules, routines, applications and the like. Computing platform 700 includes memory 702, which may comprise volatile and non-volatile memory, such as read-only and/or random-access memory (RAM and ROM), EPROM, EEPROM, flash cards, or any memory common to computing platforms). Moreover, memory 700 may comprise cloud storage, such as provided by a cloud storage service and/or a cloud connection service.

Further, computing platform 700 also includes at least one processing device 704, which may be an application-specific integrated circuit (“ASIC”), or other chipset, logic circuit, or other data processing device. Processing device(s) 704 may execute one or more application programming interface (APIs) (not shown in FIG. 5) that interface with any resident programs, such as instructions 710 or 712 or the like, stored in the memory 702 of the computing platform 700 and any external programs. Processing devices(s) 704 may include various processing subsystems (not shown in FIG. 5) embodied in hardware, firmware, software, and combinations thereof, that enable the functionality of computing platform 700 and the operability of the computing platform 700 on the distributed computing network 510 (shown in FIG. 4). For example, processing subsystems allow for initiating and maintaining communications and exchanging data with other networked devices. For the disclosed aspects, processing subsystems of processing device 704 may include any subsystem used in conjunction with instructions 710 or 712 and related tools, routines, sub-routines, algorithms, sub-algorithms, sub-modules thereof.

Computing platform 700 may additionally include a communications module (not shown in FIG. 5) embodied in hardware, firmware, software, and combinations thereof, that enables electronic communications between the computing platform 700 and other network devices, such as user device 700. Thus, communication module may include the requisite hardware, firmware, software and/or combinations thereof for establishing and maintaining a network communication connection with one or more network devices.

Memory 702 of computing platform 700 stores instructions 710 that are configured to receive an input 720 from a resource-providing entity 734 in control of the user device 600, that requests performance of a resource event 722 between the resource-providing entity 734 and a resource-receiving entity 736. The resource event 722 is to be performed using resources 726 from a resource depository 724 in control of the resource-providing entity 334.

In specific embodiments of the invention, in which the resource event 722 is a financial transaction, the input 720 may be swiping a magnetic card or reading a chip within a smart card to request a financial transaction between the user/payor and a merchant/payee. In such embodiments of the invention, the financial transaction is performed using funds from a payment account in control of the user/payor. Other inputs 720 may also be provided and are within the purview of the present invention, such as, but not limited to, contactless communication of payment credentials from a digital wallet within the user device 600 or the like.

In response to receiving the input 720, the instructions 710 are configured to perform a determination 730 that verifies/determines that the resources 726 in the resource depository 724 are of a first resource type 732 and that the resource-receiving entity 734 is configured to receive resources of a second resource type 738 that is different from the first resource type 732.

In those embodiments of the invention, in which the resource event 732 is a financial transaction, the determination 730 entails determining that the funds in the payment account of a first currency type while the merchant/payee accepts payment in a second currency type. In other words, the user/payee is located in a country other than their country of residency or the country in which their payment accounts are held.

In response to determination 730, the instructions 710 are further configured to perform a determination 740 that renders/determines a first resource event volume 742 for performing the resource event 722. The first resource event volume 742 is of the first resource type 732 and is determined by applying a resource type conversion rate 744 to a second resource event volume 746 of the second resource type 738 required for performing the resource event 722.

In those embodiments of the invention in which the resource event 732 is a financial transaction, the determination 740 involves determining a payment amount for the transaction in the first currency type by applying a foreign exchange (FX) rate to the payment amount of the second currency type. In addition, the payment amount may include a network exchange rate assessment and a card processing assessment in the currency type of the user/payor. Thus, the user/payee can lock-in or guarantee the FX rate at the time the financial transaction is initiated (e.g., at the merchant while conducting the transaction), as opposed to having the FX rate applied during settlement of the transaction, which may occur one or more days after the transaction is initiated. Moreover, the FX rate that is applied may be a rate offered by the financial institution associated with the payment account, a merchant negotiated rate, or any other rate offered at that moment in time.

In response to determining the first resource event volume 742, the instructions 310 are configured to generate and communicate a signal 750 to the user device 600 that is configured to present, on one or more of the user interfaces 606, an option 752 for selecting between performing the resource event 722 with the first resource event volume 742 of the first resource type 732 or the second resource event volume 746 of the second resource type 738. In addition, the signal may be configured to present the conversion rate 744 used to determine the first resource event volume 742.

In those embodiments of the invention in which the resource event 732 is a financial transaction, the signal 750 is configured to be received by the user device 600 and present to the user/payor the option to select between conducting the financial transaction with a payment amount of the user's/payor's preferred currency type (i.e., the currency type associated with the user's/payor's payment account) or the payment amount of the currency type accepted by the merchant/payee. In addition, the signal 750 may be configured to present to the user/payor the exchange rate used to determine the payment amount of the user/payor's preferred currency type. As such, the user/payor can select between (i) a locked-in/guaranteed payment amount or their currency type or, if the user/payor does not prefer the FX rate used to determine the payment amount or believes that the FX rate will move in their favor between now and the time of settlement, (ii) payment amount in the merchant/payor's accepted currency type with the exchange to their currency type occurring at the time of settlement.

In response to the user selecting the first resource event volume 742, the resource event 722 is performed with resources 726 being provided to the resource-receiving entity 736 from the resource depository 724 in a volume equal to the selected first resource event volume 742. In specific embodiments of the invention, the resource event is performed via a real-time processing network that provided for the resources to be transferred to a resource depository in control of the resource-receiving entity in real-time.

In those embodiments of the invention in which the resource event 732 is a financial transaction, in response to the user/payor selecting the payment amount of the user's/payor's preferred currency type (i.e., the currency type associated with the user's/payor's payment account), the financial transaction is performed with funds being provided to the merchant/payee from the user's/payor's payment account in the amount equal to the payment amount that the user/payor selected. Metadata is attached to the payment instructions that insures that the payment is settled in the amount specified using the user's payor's currency type. In specific embodiments of the invention, the financial transaction may be performed by a real-time payment network that provides for the settlement of the transaction (payment to the payor) to occur in real-time to when the transaction was initiated.

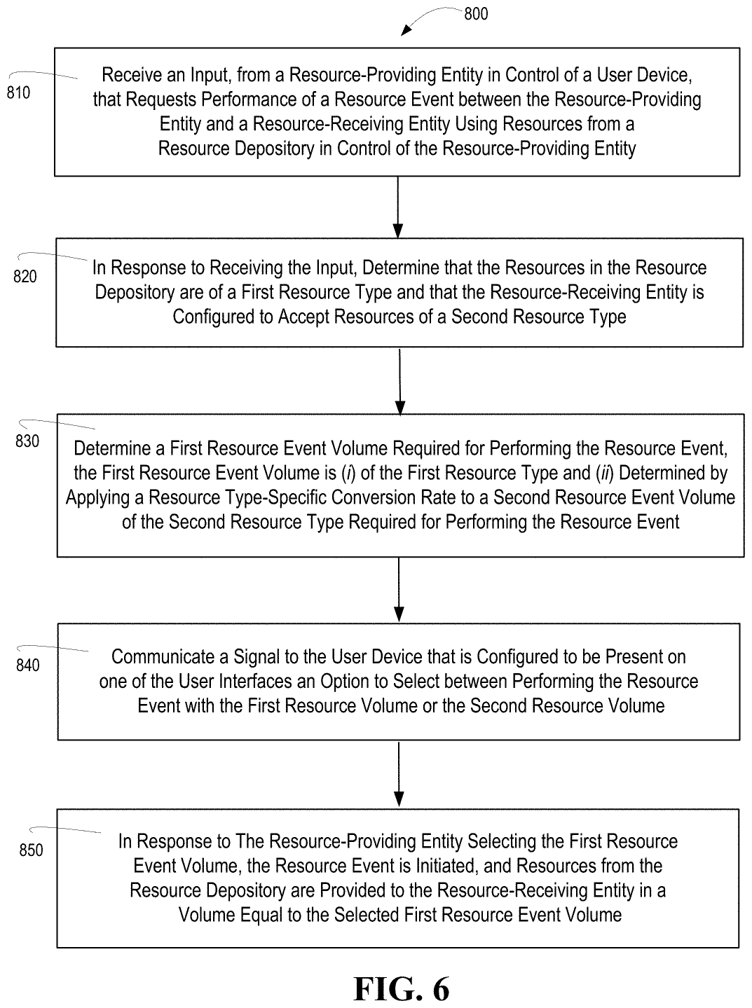

Referring to FIG. 6 a flow diagram of a method 800 for dynamic resource conversion and processing, in accordance with embodiments of the present invention. At Event 810, an input is received, from a resource-providing entity in control of a user device, that requests performance of a resource event between the resource-providing entity and a resource-receiving entity. The resource event is performed using resources from a resource depository in control of the resource-providing entity.

In response to receiving the input, at Event 820 a determination is performed that verifies/determines that the resources in the resource depository are of a first resource type and that the resource-receiving entity is configured to receive resources of a second resource type that is different from the first resource type. In response to determining that resource types are different, at Event 830, a second determination is performed to determine/calculate a first resource event volume for performing the resource event. The first resource event volume is of the first resource type and is determined by applying a resource type conversion rate to a second resource event volume of the second resource type required for performing the resource event.

In response to determining the first resource event volume, at Event 840, a signal is generated and communicated to the user device that is configured to present, on one or more of the user interfaces, an option for selecting between performing the resource event with the first resource event volume of the first resource type or the second resource event volume of the second resource type.

In response to the user selecting the first resource event volume, at Event 850, the resource event is performed with resources being provided to the resource-receiving entity from the resource depository in a volume equal to the selected first resource event volume. In specific embodiments of the invention, the resource event is performed via a real-time processing network that provided for the resources to be transferred to a resource depository in control of the resource-receiving entity in real-time.

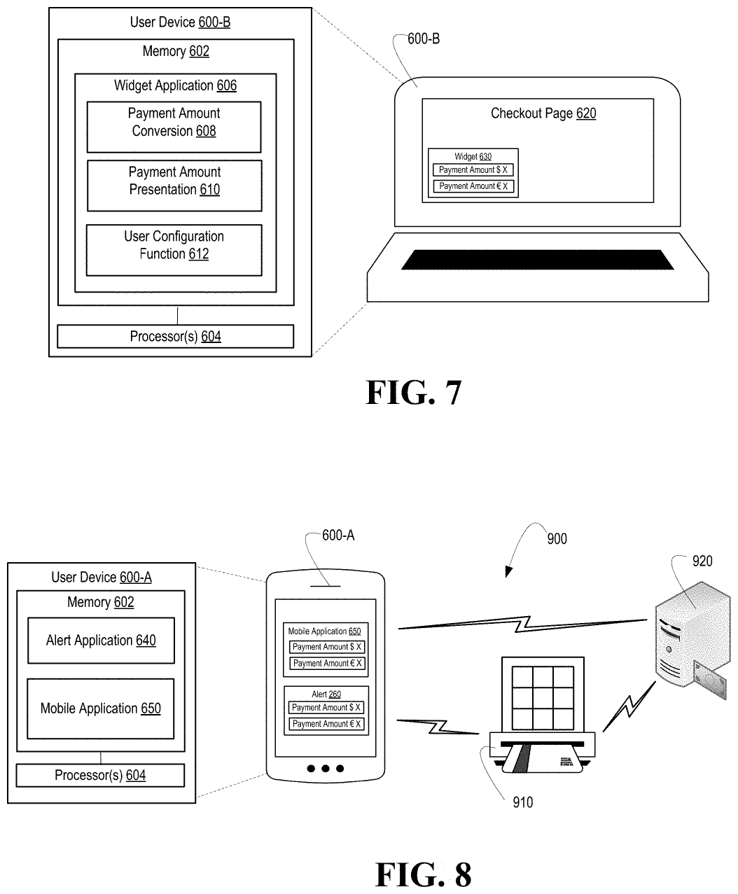

Referring to FIG. 7, a schematic and block diagram is presented of a user device 600-B configured for dynamic resource conversion and processing in accordance with embodiments of the present invention. The user device 600-B may be any computing device, such as PC, laptop computer, tablet computer, mobile communication device or the like that provides network-access to the Internet for conducting electronic commerce transactions. The user device 600-B includes a memory 602 and one or more processors 604 in communication with the memory. The memory stores widget application 606 that is executable by the one or more processors and is configured to 612 to perform or initiate payment amount conversion 608. In this regard, the widget application 606 may interface with the merchant website, such that, once a payment amount is determined for a currency type that is different than the user's preferred payment type (e.g., the merchant website accepts euros and the user prefers dollars), the widget determines or initiates determination (i.e., via the communication network) of the payment amount in the user's preferred currency. The determination occurs by applying a foreign exchange (FX) rate to the payment amount in the currency type accepted by the merchant site. The widget application 608 further includes a payment amount presentation 610 feature that is configured to generate a signal for display of the widget 630, as a pop-up window or the like, within the checkout page 620 of the merchant site. The widget 630 is configured to display options for selecting between the payment amount in the user's preferred currency or the payment amount in the merchant's currency, such that a user may choose between the two different payment options. The widget application 606 additionally includes a user configuration function 612 configured to allow the user to configure parameters associated with the widget application 606, such as, but not limited to, the user's preferred currency type, which types of merchant sites the widget is applicable to, the FX rate to be used, where the widget 230 should be displayed on the display of the user device and the like.

Referring to FIG. 8, a schematic and block diagram is presented of a system 900 for dynamic resource conversion and processing, in accordance with embodiments of the present invention. The system includes a user device 600-A, a POS terminal 910 and a back-end payment processing apparatus 920. The user device 600-A, which may comprise a mobile communication device, such as a smart telephone device or the like, includes a memory 602 and one or more processors 604 in communication with the memory 602. The memory 602 stores alert application 640 and/or mobile application 650 that are executable by the one or more processors and configured to, in response to receiving a signal from the POS terminal 910 or the back-end payment processing apparatus 920, display an alert 660 that includes the payment options or launch the mobile application 650, which displays the payment options. In one embodiment of the invention, the POS terminal 910 may interact directly with the user device 600-A, via a short-range wireless communication network/protocol, such as NFC, Bluetooth® or the like to communicate a signal to the user device that includes the payment options. In other embodiments of the invention, the back-end payment processing apparatus 920 may be configured to communicate the signal to the user device via a cellular network and/or the Internet. The signal may trigger the alert application 640 to display an alert 660 on the user device or, alternatively, the signal may trigger launch of the mobile application, such as financial institution mobile application or a merchant-specific mobile application and, subsequent display of the payment options within the mobile application.

Thus, present embodiments of the invention provide for a resource-providing entity to select, while initiating a resource event, between (i) a first resource event volume of a first resource type (i.e., a resource type associated with or preferred by the resource-providing entity) and (ii) a second resource event volume of a second type (i.e., a resource type associated with or preferred by the resource-receiving entity). Thus, the first resource event volume is determined by applying a conversion rate to the second resource event volume near to or in conjunction with the initiation of the resource event, as opposed to conventional processing in which the conversion rate is applied at or near the conclusion of the resource event. As a result of the invention, the first entity benefits from being able to select between a predetermined resource event volume of the first resource type at the onset of the resource event or, if the first entity believes it to be in their best interest, or an unknown resource event volume of the first resource type, since conversion from the second resource type to the first resource type will occur at a later point in time (i.e., at or near the conclusion of the resource event).

The features, functions, and advantages that have been discussed may be achieved independently in various embodiments of the present invention or may be combined with yet other embodiments, further details of which can be seen with reference to the following description and drawings.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for dynamic resource conversion, the system comprising:
a mobile device in possession of a user and including a memory, at least one computing processor in communication with the memory, and one or more user interfaces in communication with the at least one processor; and
a plurality of computing-implemented instructions stored in the memory, executable by the at least one computing processor and configured to:
receive, as the user is located within a non-domestic physical locale of an object provider, at least one input that identifies (i) an object at the physical locale, and (ii) a first resource volume of a first resource type required for acquiring the object;
in response to receiving the at least one input, determine that resources in a first resource depository held by the user are of a second resource type different than the first resource type;
initiate determination of a second resource volume required for acquiring the object, wherein the second resource volume is (i) of the second resource type, and (ii) determined by applying a resource type conversion rate to the first resource volume of the first resource type required for performing acquisition of the object; and
communicate a first signal to at least one of the user interfaces that is configured to present on one of the one or more user interfaces a definitive volume including at least the second resource volume as resources of the second resource type required for acquiring the object.

2. The system of claim 1, wherein the instructions are further configured to, in response to the user initiating, at the physical locale, a subsequent resource event that includes the object, communicate a second signal to the mobile device that (i) is configured to be outputted by at least one of the one or more user interfaces, and (ii) provides presentation of an option to perform the subsequent resource event using the second resource type in a volume that includes the second resource volume for acquiring the object.

3. The system of claim 1, wherein the subsequent resource event is initiated within a predetermined time period from when the second resource volume is presented on the user interface.

4. The system of claim 1, wherein the definitive volume of resources is further defined as an actual amount of resources (i) transferred from the first resource depository in response to a resource event that includes the object or (ii) owed by the user.

5. The system of claim 1, wherein the instructions configured to receive the input are further configured to capture an image of computer-readable indicia located on the object and read the computer-readable indicia to identify (i) the object, and (ii) the first resource volume of a first resource type.

6. The system of claim 1, wherein the first signal further provides presentation of the resource conversion rate used to determine the second resource volume.

7. The system of claim 1, wherein the instructions are further configured to:
receive, as the user is located within a physical locale of an object provider, the at least one input that further identifies information related to the object in a first language;
determine that the user prefers a second language;
translate the information related to the object from the first language to the second language; and
communicate a second signal to the mobile device that is configured to present on one of the one or more user interfaces the information related to the object in the second language.

8. The system of claim 1, wherein the instructions are further configured to:
receive, as the user is located within the physical locale of an object provider, the at least one input that further identifies first measurement information of a first measurement type associated with the object;
determine that the user prefers measurement information of a second measurement type;
determine second measurement information of the second measurement type by applying a measurement conversion scale to the first measurement information; and
communicate a second signal to the mobile device that is configured to present on one of the one or more user interfaces the second measurement information.

9. The system of claim 1, wherein the instructions are further configured to:
receive, as the user is located within the physical locale of an object provider, the at least one an input that further identifies first health-related information of a first type associated with the object;
determine that the user prefers health-related information of a second type;
determine second health-related information of the second type by applying a health-related conversion scale to the first health-related information; and
communicate a second signal to the mobile device that is configured to present on one of the one or more user interfaces the second health-related information.

10. A computer-implemented method for dynamic resource conversion, the method executed by one or more computing processor devices and comprising:
receiving, by a mobile device in possession of a user located within a physical locale of an object provider, at least one input that identifies (i) an object within the physical locale, and (ii) a first resource volume of a first resource type required for acquiring the object;
in response to receiving the at least one input, determining that resources in a first resource depository held by the user are of a second resource type different than the first resource type;
initiating determination of a second resource volume required for acquiring the object, wherein the second resource volume is (i) of the second resource type, and (ii) determined by applying a resource type conversion rate to the first resource volume of the first resource type required for performing acquisition of the object; and
communicating a first signal to the mobile device that is configured to present on one of the one or more user interfaces a definitive volume of resources of the second resource type including at least the second resource volume as required for acquiring the object.

11. The computer-implemented method of claim 10, further comprising:
in response to the user initiating, at the physical locale, a subsequent resource event that includes the object, communicating a second signal to the mobile device that (i) is configured to be outputted by at least one of the one or more user interfaces, and (ii) provides presentation of an option to perform the subsequent resource event using the second resource type in a volume that includes the second resource volume for acquiring the object.

12. The computer-implemented method of claim 10, wherein the subsequent resource event is initiated within a predetermined time period from when the second resource volume is presented on the user interface.

13. The computer-implemented method of claim 10, wherein the definitive volume of resources is further defined as an actual amount of resources transferred from the first resource depository to a second resource depository held by the object provider in response to a resource event that includes the object.

14. The computer-implemented of method of claim 10, wherein receiving the at least one input further comprises receiving, by a mobile device in possession of a user located within a physical locale of an object provider, the least one input that identifies information related to the object in a first language,
wherein the method further comprises:
determining that the user prefers a second language;
translating the information related to the object from the first language to the second language; and
communicating a second signal to the mobile device that is configured to present on one of the one or more user interfaces the information related to the object in the second language.

15. The computer-implemented method of claim 10, wherein receiving the at least one input further comprises receiving, by a mobile device in possession of a user located within a physical locale of an object provider, the at least one input that further identifies first measurement information of a first measurement type associated with the object,
wherein the method further comprises:
determining that the user prefers measurement information of a second measurement type;
determining second measurement information of the second measurement type by applying a measurement conversion scale to the first measurement information; and
communicating a second signal to the mobile device that is configured to present on one of the one or more user interfaces the second measurement information.

16. The computer-implemented method of claim 10, wherein receiving the at least one input further comprises receiving, by a mobile device in possession of a user located within a physical locale of an object provider, the at least one an input that further identifies first health-related information of a first type associated with the object;
wherein the method further comprises:
determining that the user prefers health-related information of a second type;
determining second health-related information of the second type by applying a health-related conversion scale to the first health-related information; and
communicating a second signal to the mobile device that is configured to present on one of the one or more user interfaces the second health-related information.

17. A computer program product comprising:
a non-transitory computer-readable medium comprising:
a first set of codes for causing a computer to receive, by a mobile device in possession of a user located within a physical locale of an object provider, at least one input that identifies (i) an object, and (ii) a first resource volume of a first resource type required for acquiring the object provided within the physical locale;
a second set of codes for causing a computer to, in response to receiving the at least one input, determine that resources in a first resource depository held by the user are of a second resource type different than the first resource type;
a third set of codes for causing a computer to initiate determination of a second resource volume required for acquiring the object, wherein the second resource volume is (i) of the second resource type, and (ii) determined by applying a resource type conversion rate to the first resource volume of the first resource type required for performing acquisition of the object; and
a fourth set of codes for causing a computer to communicate a first signal to at least one user interface on the mobile device that is configured to present on the user interface a definitive volume of resources of the second resource type including at least the second resource volume as required for acquiring the object.

18. The computer program product of claim 17, further comprising a fifth set of codes for causing a computer to, in response to the user initiating, at the physical locale, a subsequent resource event that includes the object within a predetermined time period from when the second resource volume is presented on the user interface, communicate a second signal to the mobile device that (i) is configured to be outputted by at least one of the one or more user interfaces, and (ii) provides presentation of an option to perform the subsequent resource event using the second resource type in a volume that includes the second resource volume for acquiring the object.

19. The computer program product of claim 10, wherein the first set of codes is further configured to receive, by a mobile device in possession of a user located within the physical locale of an object provider, the least one input that identifies information related to the object in a first language,
wherein the computer-readable medium additionally includes:
a fifth set of codes for causing a computer to determine that the user prefers a second language;
a sixth set of codes for causing a computer to translate the information related to the object from the first language to the second language; and
a seventh set of codes for causing a computer to communicate a second signal to the mobile device that is configured to present on one of the one or more user interfaces the information related to the object in the second language.

20. The computer program product of claim 19, wherein the first set of codes is further configured to receive, by a mobile device in possession of a user located within a physical locale of an object provider, the at least one input that further identifies at least one of first measurement information of a first measurement type and first health-related information of a first heal-related type associated with the object,
wherein the computer program product further comprises:
a fifth set of codes for causing a computer to determine that the user prefers at least one of measurement information of a second measurement type and health-related information of a second health-related type;
a sixth set of codes for causing a computer to determine at least one of second measurement information of the second measurement type and second health-related information of the second health-related type by applying at least one of a measurement conversion scale to the first measurement information and a health-related conversion scale to the first health-related information; and
a seventh set of codes for causing a computer to communicate a second signal to at least one user interface on the mobile device that is configured to present on the user interface at least one of the second measurement information and the second health-related information.
